(19) United States
(12) Patent Application Publication
(10) Pub. No.: US 2007/0136097 A1
(43) Pub. Date: Jun. 14, 2007

(54) Risk reduction method for surgical procedures

(75) Inventors: Stephen L. Demers, Tampa, FL (US); Richard C. Karl, Tampa, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: Surgical Safety Institute, LLC, Tampa, FL (US)

(21) Appl. No.: 11/636,272

(22) Filed: Dec. 8, 2006

Related U.S. Application Data
(60) Provisional application No. 60/749,195, filed on Dec. 9, 2005.

(51) Int. Cl. G06Q 10/00; G05B 19/418

(52) U.S. Cl. 705/2; 705/8

(57) ABSTRACT

A system and method of training, and the equipment with which to effectively decrease the chance of surgical error, and, when an error does occur, to recognize the problem and fix it is disclosed. The application of crew management techniques combined with the surgical safety computers, safe screens and drop down emergency checklist menus provides the surgical team with the tools and an understanding of their use to increase the safety afforded the surgical patient.

### CROSS-REFERENCE TO RELATED APPLICATION

The present application claims the benefit of previously filed co-pending Provisional Patent Application, Ser. No. 60/749,195 filed on Dec. 9, 2005.

### FIELD OF INVENTION

This invention relates, generally, to a system and method for risk reduction in operating rooms where surgery is taking place. More specifically, it is a method and system for incorporating surgical team training, a series of checklists and real time monitoring and updating of such checklists in the operating room environment before, during and after surgical procedures take place.

### BACKGROUND OF THE INVENTION

Though health care workers are no more infallible than any other group of human beings, the consequences of error in their work can be more tragic. In a sense, it is not that the chance for error is different in medicine, it is that the capacity for catastrophe is greater. In medicine in general, and surgical suites in particular, it is conceivable that error, or more accurately, a chain of errors, can be detected, minimized and corrected with simple techniques. p Aviation has long understood the concept of cooperative interaction among team members, sometimes called crew resource management. Today there is a call to use aviation techniques in an effort to reduce medical error, yet the translation of cockpit practice into the medical and surgical world is not easy. Many attempts have proven to be simplistic, superficial or fatuous.

This invention provides a system and method of training and the equipment with which to effectively decrease the chance of surgical error and, when an error does occur, to recognize the problem and fix it. This unique application of crew management techniques combined with the surgical safety computers, safety screens and drop down emergency checklist menus provides the surgical team with the tools, and an understanding of their use, to increase the safety afforded the surgical patient.

This risk reduction system and method is based on the premise that bright, hard working, altruistic individuals who have chosen the surgical world for their life's work are highly motivated to minimize error, detect error when it occurs, and to fix those errors. The current medical culture of blame and shame (incident reports, law suits, sanctions, etc.) has done little to reduce error. In fact, it is estimated that 100,000 lives a year are cut short by medical mishap and that half of these deaths involve a hospital based surgical experience. It is this disparity between intent on the part of good people and the unfortunate outcome that this disclosure addresses.

The essence of this disclosure is the combination of team training and the coordination of information pertinent to patient safety at a single location. All data important to the safe conduct of a surgical operation are clearly visible to every team member in the operating room. A standardized surgical brief increases efficiencies and decreases surprises. Checklists prompt caregivers to execute certain functions, but they do not tell any trained professional what to do.

The benefits of the use of this system and method are increased operating room efficiencies and reduced turnover time, reliable evidence based algorithms for the management of unusual operating room situations, increased nurse, anesthesia, and surgical job satisfaction, reduction of frustration and improved patient safety. This novel system and method of risk reduction is straightforward, intuitive, easy to learn and powerful in its application.

As is well known in the art, methods to ensure operating room safety regarding control of surgical tools and materials through checklists and computer processes are shown in such patents as U.S. Pat. No. 6,943,663 and the like.

Also, methods to ensure operating room safety regarding documentation of patient information and care are well known as shown in U.S. Pat. No. 5,265,010 and U.S. Patent Application Publication No. 2004/0044546.

In U.S. Patent Application Publication No. 2003/0204411 filed by Beyersdorf titled Medical Security System a method for preparing a patient for a medically indicated procedure such as an operation, is presented with which steps necessary for the procedure are checked and the completion of those steps verified. The method proceeds by generating a list of tasks to be carried out and a list of preparatory items in association with those tasks. Data are entered in response to prompts for the list of preparatory items and a list of tasks and of preparatory items is updated appropriately in response to that data input. This feedback looping process continues until a closed matrix of accomplished items and tasks is presented to the system and the system indicates that the patient is ready for the indicated procedure. The invention has the advantage of increased efficiency by precluding the necessity for personnel not normally responsible for a given task or item, from having to carry that item out, when it was omitted in a previous processing stage. But, the Beyersdorf publication does not disclose the additional system of real time monitoring on an operating room video screen with drop down emergency checklists and additional menus, and further updating of checklist status before, during, and after a surgical procedure.

Therefore, there is a need for method and system for incorporating a series of checklists, and real time monitoring and updating of such checklists, in the operating room environment before, during and after surgical procedures are taking place.

It is thus an object of this invention to provide a system and method for risk reduction in operating room environments.

It is another object of this invention to provide a method and system for incorporating a simple, easy to follow method of ensuring all patient data and surgical steps are displayed and updated on a real time basis and that all members of the surgical team have real time information available to all at the same time along with drop down menus populated with real time data to assist the surgical team in routine and emergency situations.

Therefore, there is a need for a system and method for reducing risk in operating room environments through use of flight crew type checklists and real time situational monitoring of important data by all members of the surgical team.

This and other objects of the invention will in part be obvious and will in part appear hereinafter.

### BRIEF DESCRIPTION OF THE FIGURES

The invention will now be described, by way of example only, with reference to the accompanying figures in which:

FIG. 1 depicts a communications flowchart of the risk reduction system.

FIG. 2 depicts a flowchart of the overall method of risk reduction.

FIG. 3 depicts a flowchart of one of the checklist processes used in the method of risk reduction.

FIG. 4 is an example of the checklist procedure used in the preferred embodiment of the invention.

### SUMMARY OF THE INVENTION

This invention provides a system and method of training, and the equipment with which to effectively decrease the chance of surgical error, and, when an error does occur, to recognize the problem and fix it. The unique application of crew management techniques combined with the surgical safety computers, safe screens and drop down emergency checklist menus provides the surgical team with the tools and an understanding of their use to increase the safety afforded the surgical patient.

The essence of this disclosure is the combination of complete team preparation and the coordination of information pertinent to patient safety at a single location. All data important to the safe conduct of a surgical operation are clearly visible to every team member in the operating room. A standardized surgical brief increases efficiencies and decreases surprises. Checklists prompt caregivers to execute certain functions, but it does not tell any trained professional what to do.

### DESCRIPTION OF THE PREFERRED EMBODIMENT

The method and system for incorporating a series of checklists and real time monitoring and updating of such checklists in the operating room environment before, during, and after surgical procedures take place will now be described in more detail by referring to the figures and the discussion below.

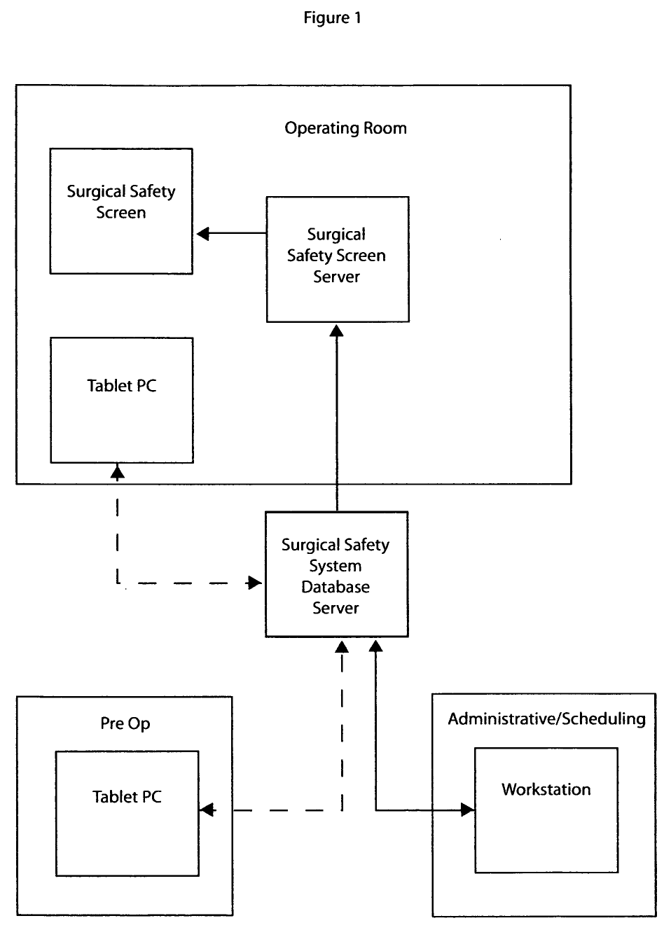

Referring now to FIG. 1 a communications flowchart of the overall system is disclosed. The system consists of a database server where all the patient and operating room data is stored. The data contained in the database server is acquired through a number of input devices. In the preferred embodiment disclosed in the figure the first input device is the administration/scheduling workstation where basic patient information and operating room information are inputted. This information can also be obtained via a computer interface board to the medical organization's main computer if the medical organization has computerized this kind of information already. Two tablet PCs are also depicted in the preferred embodiment shown in FIG. 1. These tablet PCs are remotely in communication with the database server. Generally this remote communication is via a wireless network but any type of remote networking can be used as will be readily recognized by those skilled in the art. These tablet PCs are used by the PreOP nurse and Operating Room nurse to continue to input information in preparation for the surgical procedure and during the surgical procedure respectively. Another tablet PC could also be used for the Recovery Room nurse to continue to update patient status. Of course numerous other members of the surgical team could have tablet PCs to input data to the database server as is well known to those skilled in the art.

Also shown on FIG. 1 is the screen server that is used with the operating room screen to display the data stored in the database server in accordance with the formatting prescribed by the screen server. This formatting would include basic patient and procedure information along with numerous drop down screens to display information or checklists directed to a particular circumstance or emergency situation such as an unexpected drop in the patient's blood pressure.

The system then, as shown in FIG. 1, allows for real time updating and monitoring of patient and procedure information on a display screen in the operating room so that all members of the operating team are exposed to and aware of up-to-the-minute pertinent information, whether the operation proceeds routinely or if emergency situations arise. Drop down menus are available from the screen server that are immediately populated with pertinent information from the database server as the surgical team needs more information at certain times during the procedure.

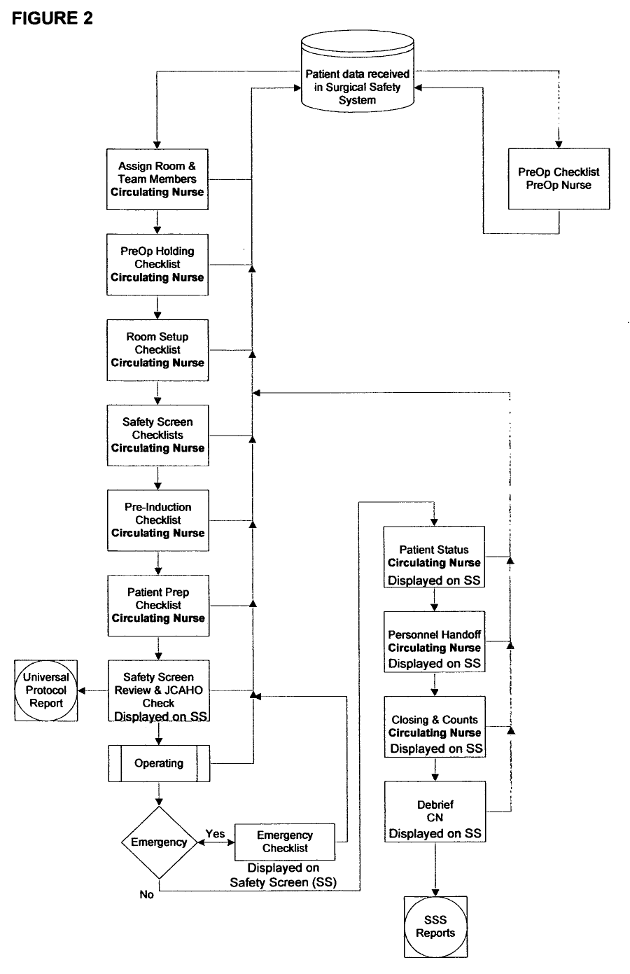

Referring now to the overall flowchart of FIG. 2 a possible implementation of the method of operating the system is disclosed. This method shows inputting of data from a number of different nurses and administrative personnel. The inputted data is immediately stored in the database server and returned to the team members in updated versions through the screen server and displayed on the operating room screen. Routine checklists, emergency checklists, and drop down menus are also stored and constantly updated in the screen server with new data from the database server. These different checklists and drop down menus are available on demand by the surgical team and readily viewable by the whole surgical team.

Additionally the method, when implemented in software as can easily be done by those skilled in the art after review of FIG. 2, allows for report generation and storage for review by the surgical team or other interested parties.

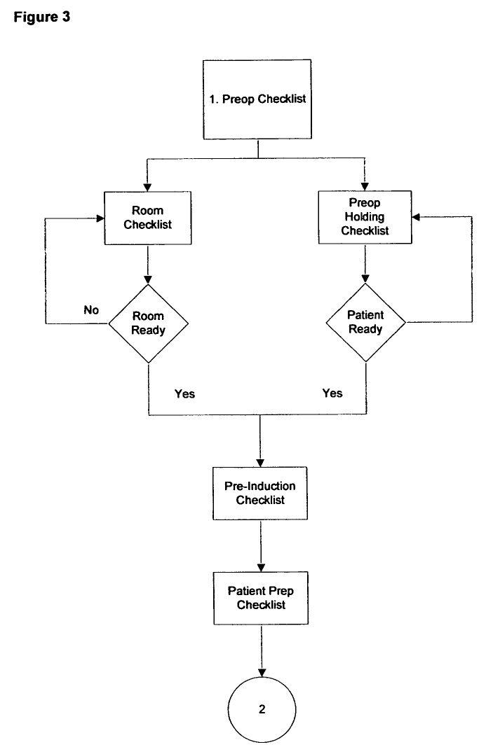

Referring now to FIG. 3 a more detailed flowchart of the checklist process of the preferred embodiment of this invention is disclosed. This checklist system shown in FIG. 3 involves the pre-operation procedures necessary to begin the surgical process. Yes/No decision points during the checklist process ensure no patient surgery is actually started until all the appropriate data is inputted into the database server and is ready for display on the operating room screen. Once this particular checklist procedure is accomplished further checklist procedures can begin as shown in the figure.

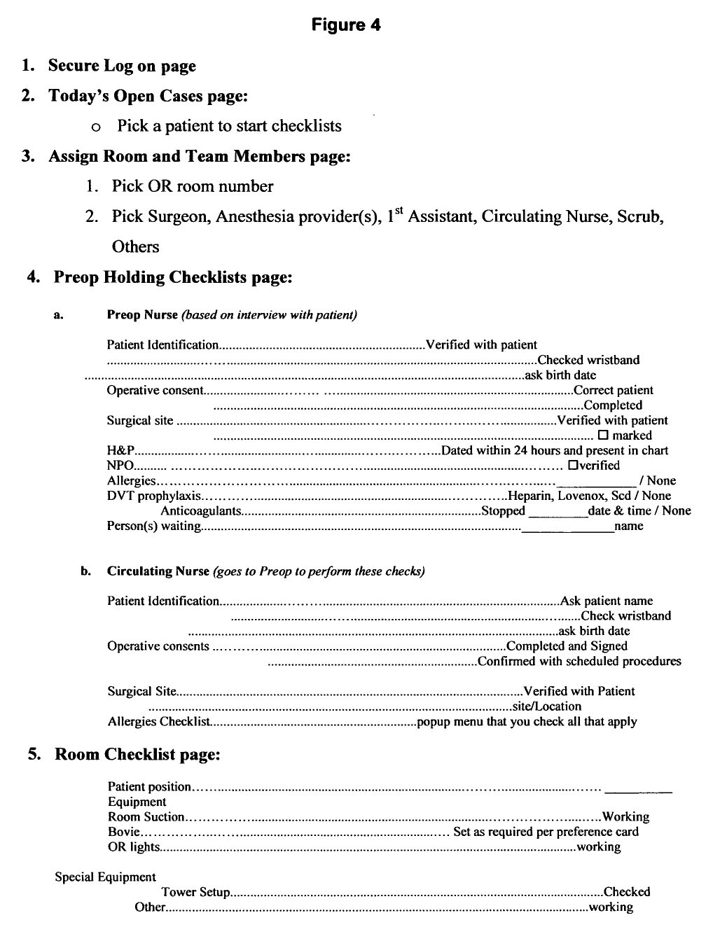

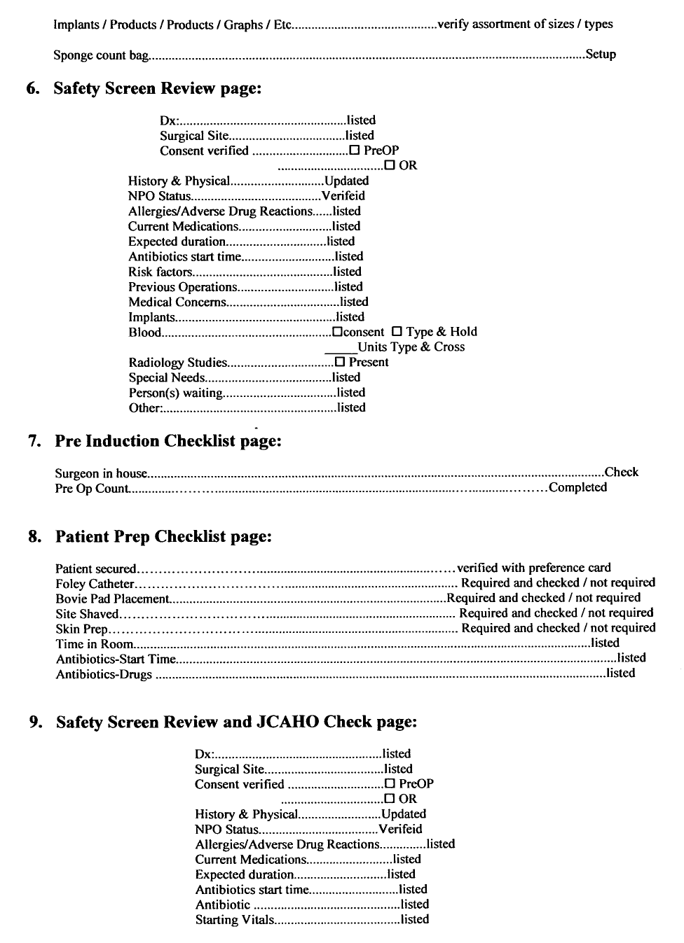

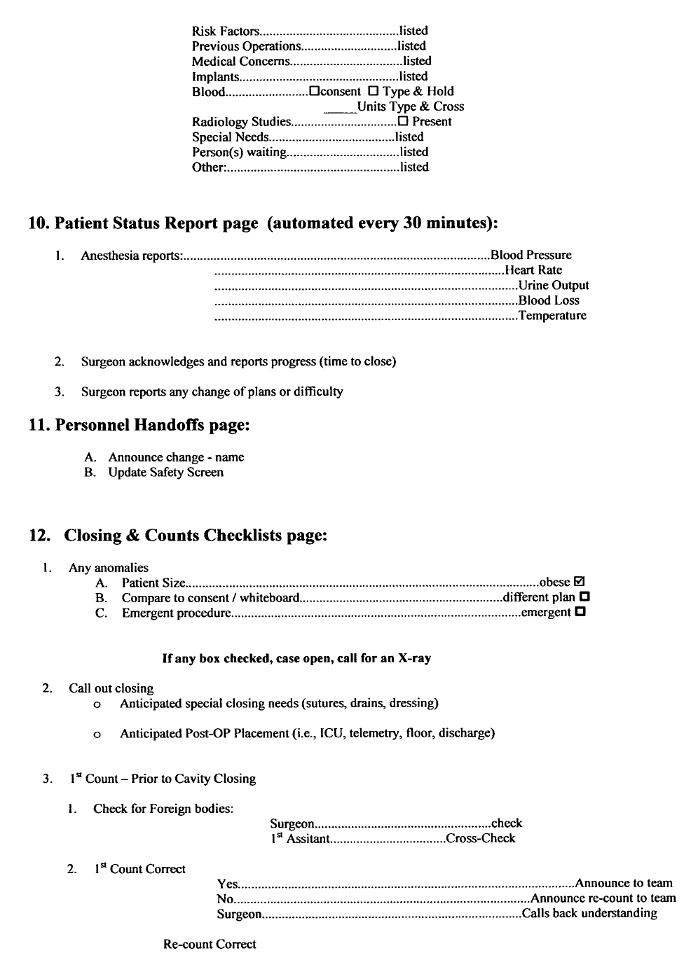

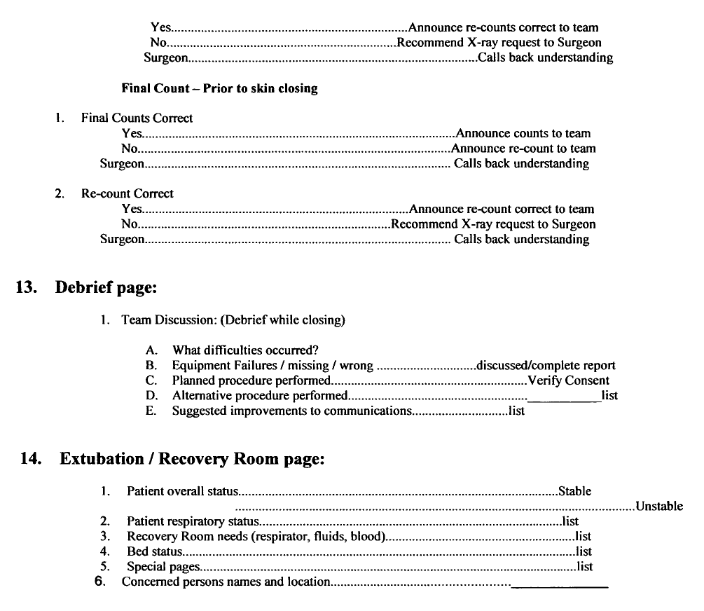

The checklists of this invention rely on substantive feedback. They are not simply “to do” lists or ways to gather data. They are check, cross/ check formatted. FIG. 4 shows an example of the checklist procedure used in the preferred embodiment of the invention.

The following is a list of emergency checklists used in the preferred embodiment of this invention:

1. Oliguria

2. Hypotension

3. Bradycardia

4. Hyperthermia

5. Hypercalcemia

6. Thyroid Storm

7. Hypertension

8. Hypothermia

9. Rash

10. Coagulophathy
A. Excess bleeding

11. Equipment failure

12. PaO2—Hi/Low, hypoxia

13. PcO2—Hi/Low, hypocapnia

14. Bleeding—Surgical/Non Surgical

15. Tachacardia

16. Rhythm change

17. Blood color change—from what to what

18. Stay calm, repair, remove, call for help

19. Inadvertent injury

20. Hypoglycemia

21. hyperglycemia

Although this invention has been described in the form of a preferred embodiment, many modifications, additions, and deletions, may be made thereto without departure from the spirit and scope of the invention, as set forth in the following claims.

What is claimed is:

1. A system for incorporating a series of checklists and real time monitoring and updating of such checklists in an operating room environment before, during, and after surgical procedures take place comprising;
a database server;
said database server capable of storing patient and operating room data;
one or more input devices;
said input devices in communication with said database server such that information entered into said input devices is stored in said database server;
an operating room display screen;
a screen server;
said screen server in communication with said database server;
said screen server capable of formatting information stored in said database server for display on said operating room display screen such that displays include drop down screens for display of information or checklists; and,
said input devices, screen server, and database server allowing for real time updating and monitoring of patient and procedure information on said operating room display screen so that all members of an operating team are exposed to and aware of real time pertinent information in routine or emergency surgical situations.

2. The system of claim 1 wherein one of said input devices is an administration/scheduling workstation or computer interface where basic patient information and operating room information are inputted and one or more of said input devices are remotely connected tablet PCs.

3. The system of claim 2 wherein said tablet PCs are remotely connected to said database server using a wireless connection.

4. The system of claim 2 wherein said tablet PCs are used by a PreOP nurse, Operating Room nurse, and other members of a surgical team to continue to input information in preparation for the surgical procedure and during the surgical procedure respectively.

5. The system of claim 2 wherein one said tablet PC is used for a Recovery Room nurse to update patient status after a surgical procedure.

6. The system of claim 1 wherein said checklists are check and cross checked formatted.

7. A method for incorporating a series of checklists and real time monitoring and updating of such checklists in an operating room environment before, during, and after surgical procedures take place comprising;
inputting data through one or more input devices operated by one or more operating room nurses and hospital administrative personnel;
storing said inputted data in a database server;
formatting said inputted data by use of a screen server and displaying said inputted data to surgical team members on an operating room display screen in the form of routine checklists, emergency checklists, and drop down menus; and,
constantly updating said screen server with new data from said database server and displaying said new data on said operating room display screen such that said inputted data and said new data are reviewable by a surgical team.

8. The method of claim 7 wherein one of said input devices is an administration/scheduling workstation or computer interface where basic patient information and operating room information are inputted and one or more of said input devices are remotely connected tablet PCs.

9. The method of claim 8 wherein said tablet PCs are remotely connected to said database server using a wireless connection.

10. The method of claim 8 wherein said tablet PCs are used by a PreOP nurse, Operating Room nurse, and other members of a surgical team to continue to input information in preparation for the surgical procedure and during the surgical procedure respectively.

11. The method of claim 8 wherein one said tablet PC is used for a Recovery Room nurse to update patient status after a surgical procedure.

12. The method of claim 8 wherein said checklists are check and cross checked formatted.

13. The method of claim 7 further comprising generating reports and storage of reports for review by the surgical team or other interested parties after a surgery.
